(19) United States
(12) Patent Application Publication
(10) Pub. No.: US 2007/0254654 A1
(43) Pub. Date: Nov. 1, 2007

(54) WIRELESS LOCAL AREA NETWORKS AND WIRELESS SWITCHES

(75) Inventors: Sameer KANAGALA, San Carlos, CA (US); Josh ROSENTHAL, San Jose, CA (US); Edward GEIGER, San Martin, CA (US); Michael SUEKAWA, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: SYMBOL TECHNOLOGIES, INC., Holtsville, NY (US)

(21) Appl. No.: 11/742,226

(22) Filed: Apr. 30, 2007

Related U.S. Application Data
(60) Provisional application No. 60/797,018, filed on May 1, 2006.

(51) Int. Cl. H04Q 7/20

(52) U.S. Cl. 455/435.1

(57) ABSTRACT

A wireless local area network (WLAN) includes a wireless switch coupled to a network; and a plurality of wireless access devices configured to receive outgoing data packets from the wireless switch and to provide incoming data packets to the wireless switch. The wireless switch includes a main processing element and an additional processing element.

### CROSS-REFERENCES TO RELATED APPLICATIONS

This application claims the benefit of U.S. Provisional Application No. 60/797,018, filed May 1, 2006.

### FIELD OF THE INVENTION

The present invention generally relates to wireless local area networks and wireless switches, and more particularly relates to wireless switches with a main processing element and an additional processing element.

### BACKGROUND OF THE INVENTION

In recent years, there has been a dramatic increase in the demand for mobile connectivity solutions utilizing various wireless components and wireless networks, for example, wireless local area networks (WLANs). WLANs generally include, among other things, wireless switches and access ports that communicate with mobile units using one or more RF channels. A WLAN may operate in accordance with one or more of the IEEE 802.11 standards.

WLANs can give clients the ability to “roam” or physically move from place to place without being connected by wires. In the context of a WLAN, the term “roaming” describes the act of physically moving between wireless access devices, which may be stand-alone wireless access points or wireless access ports that cooperate with one or more wireless switches located in the WLAN. Many deployments of wireless computer infrastructure, such as WLANs, involve the use of multiple wireless switches serving a number of wireless access devices. Conventional wireless switches generally function as network interfaces between wireless access devices and a traditional computer network, such as a local area network (LAN).

Depending upon its intended application, a wireless switch might require additional processing capabilities that cannot be provided by a main processor. A conventional wireless switch, however, typically only includes a single, main processor that can limit current and future applications of the wireless switch.

Accordingly, it is desirable to provide improved wireless switches and networks with additional processing capabilities. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a conceptual overview of a wireless network in accordance with an exemplary embodiment of the present invention; and

FIG. 2 is a schematic representation of a wireless switch of the wireless network of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely exemplary applications for the invention.

For the sake of brevity, conventional techniques related to WLANs, signal processing, data transmission, signaling, network control, the 802.3 and 802.11 families of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

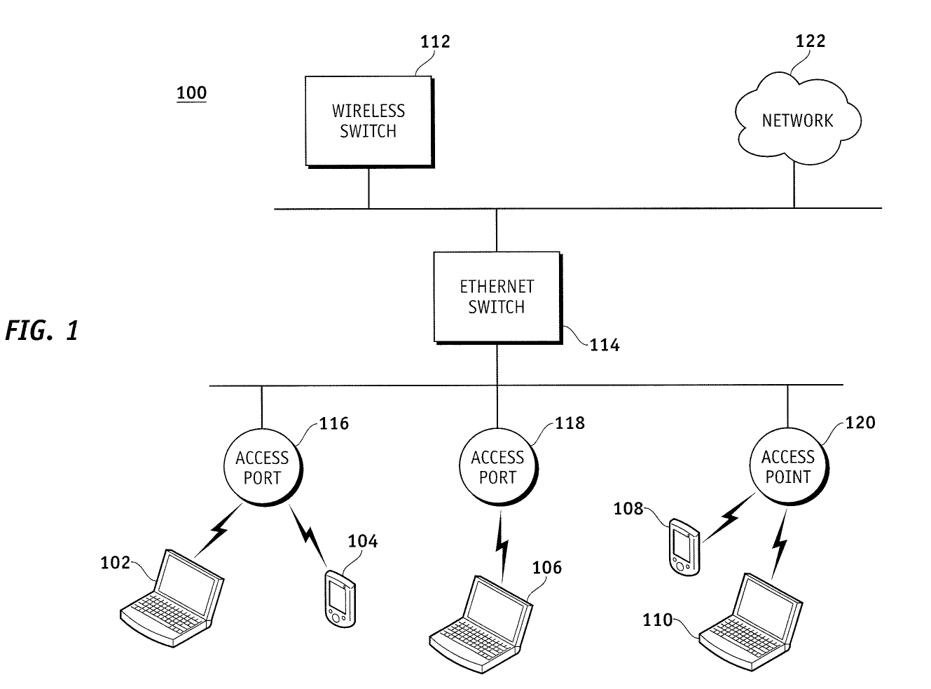

FIG. 1 is a schematic representation of a computer network 100 configured in accordance with an example embodiment of the invention. In this example, computer network 100 includes a WLAN. The computer network 100 generally includes wireless clients (identified by reference numbers 102, 104, 106, 108, and 110), a wireless switch 112, an Ethernet switch 114, and a number of wireless access devices (identified by reference numbers 116, 118, and 120). The computer network 100 may also include or communicate with any number of additional network components, such as a traditional local area network (LAN). In FIG. 1, such additional network components are generally identified by reference number 122. A practical embodiment can have any number of wireless switches, each supporting any number of wireless access devices, and each wireless access device supporting any number of wireless clients. Indeed, the topology and configuration of the computer network 100 can vary to suit the needs of the particular application and FIG. 1 is not intended to limit the application or scope of the invention in any way.

In this example, the wireless access devices 116, 118 are realized as wireless access ports, which are “thin” devices that rely on the network intelligence and management functions provided by the wireless switch 112, while wireless access device 120 is realized as a wireless access point, which is a “thick” device having the network intelligence and processing power integrated therein. Thus, the wireless access device 120 need not rely upon the wireless switch 112 for operation. Wireless access ports having conventional features that can be incorporated into the wireless access devices 116, 118, and wireless access points having conventional features that can be incorporated into the wireless access device 120 are available from Symbol Technologies, Inc. Briefly, a wireless access device as described herein is suitably configured to receive data from wireless clients over wireless links. Once that data is captured by the wireless access device, the data can be processed for communication within the computer network 100. For example, the data can be encapsulated into a packet format compliant with a suitable data communication protocol. In the example embodiment, data is routed within the computer network 100 using conventional Ethernet 802.3 addressing (including standard Ethernet destination and source packet addresses).

The wireless switch 112 is coupled to the Ethernet switch 114, which is in turn coupled to the wireless access devices 116, 118, 120. In practice, the wireless switch 112 communicates with the wireless access devices 116, 118 via the Ethernet switch 114. A given wireless switch can support any number of wireless access devices, i.e., one or more wireless access devices can be concurrently adopted by a single wireless switch (in one embodiment, a wireless access device can be adopted by only one wireless switch at a time). The wireless clients are wireless devices that can physically move around the computer network 100 and communicate with the network components 122 via the wireless access devices 116, 118, 120.

The wireless switch 112 may include various advantageous features. For example, the wireless switch 112 may utilize a field programmable gate array (FPGA) to perform the switching code. The wireless switch 112 may also be suitably configured to accept a CompactFlash card or other portable nonvolatile memory device to assist with reloading the wireless switch 112 after initial switch activation. Moreover, a USB port can be included on the exterior of the wireless switch 112 for interfacing with one or more USB devices. Another feature of the wireless switch 112 relates to the use of a boot halt to allow the user to halt the boot process in order to enter a diagnostic mode, thereby allowing advanced troubleshooting. In accordance with another feature of the wireless switch 112, booting is initiated via a NAND switch rather than a NOR switch as used in existing wireless switch devices.

The wireless switch 112 can include a physical housing that surrounds and protects the components of the wireless switch 112. A number of features, elements, and components of the wireless switch 112 may be accessible from the exterior of housing. In this example, most of these accessible and/or viewable features are located at the front face panel of wireless switch 112. In this regard, wireless switch 112 may include, without limitation: one or more system LED lights; an out-of-band management port; one or more USB ports; one or more memory card slots; and various Ethernet connectors, jacks, or ports.

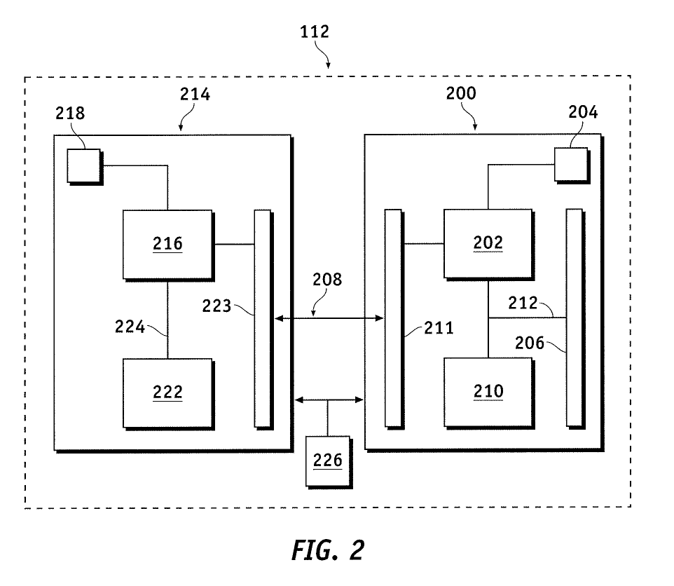

FIG. 2 is a schematic representation of the wireless switch 112 configured in accordance with an embodiment of the invention. A practical embodiment of the wireless switch 112 will include components and elements configured to support known or conventional operating features that need not be described in detail herein. Accordingly, FIG. 2 is a simplified illustration that omits elements that might otherwise be found inside the wireless switch 112.

The wireless switch 112 generally includes a main processing element 200. The main processing element 200 can also be referred to as a “motherboard.” The main processing element 200 includes a main processor 202, a suitable amount of memory 204, an external interface 206, an internal interface 208, and one or more peripheral or accessory components 210. The peripheral or accessory components 210 can include one or more of the following: an intermediate processor, a boot device selector, an additional amount of memory, a USB interface that includes a USB host controller and at least one USB port, a suitable amount of NAND flash memory, a suitable amount of NOR flash memory, and a portable flash memory card port. These and other elements of the wireless switch 112 may be interconnected together using a bus 212 or any suitable interconnection arrangement. Such interconnection facilitates communication between the various elements of the wireless switch 112. In this example embodiment, all of the illustrated components are located within a single housing, which represents the physical package for the wireless switch 112.

The main processor 202 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

The main processing element 200, particularly the main processor 202, is primarily responsible for the general operation of the wireless switch 112, e.g., switching, data communication, and wireless packet processing. The main processing element 200, particularly an intermediate processor, can further be responsible for handling inputs and outputs for the wireless switch 112 and for managing other of the peripheral or accessory components 210 for the wireless switch 112. Thus, the main processing element 200 represents the processing logic that carries out the functions, techniques, and processing tasks associated with the operation of the wireless access devices 116, 118, 120. In one embodiment, the intermediate processing element can be realized as a field programmable gate array.

The external interface 206 can be a network communication module that generally represents the hardware, software, firmware, processing logic, and/or other components of the wireless switch 112 that enable bi-directional communication between the wireless switch 112 and network components to which the wireless switch 112 is connected. For example, the external interface 206 may be configured to support 10/100 Mbps Ethernet LAN traffic. Referring to FIG. 1 as an example, the external interface 206 is suitably configured to transmit data to components on computer network 100 (such as Ethernet switch 114, access devices, and/or additional network components 122), and to receive data from components on computer network 100. In a typical deployment, the external interface 206 provides an Ethernet interface such that the wireless switch 112 can communicate with a conventional Ethernet-based computer network. In this regard, the external interface 206 may include a physical interface, such as 10/100/1000 Mbps, for connection to the computer network, and the external interface 206 (and/or main processor 202) may handle Ethernet addressing for data packets sent from the wireless switch 112.

The memory 204 may be implemented or realized with RAM memory, flash memory, ROM memory, EPROM memory, EEPROM memory, registers, a hard disk, a removable disk, a CD-ROM, or any other form of storage medium known in the art. In addition, memory 204 includes sufficient data storage capacity to support the operation of the wireless switch 112. The memory 204 can be coupled to the main processor 202 to such that the main processor 202 can read information from, and write information to, the memory 204. In the alternative, the memory 204 may be integral to the main processor 202. As an example, the main processor 202 and the memory 204 may reside in a suitably configured ASIC.

In an embodiment in which the peripheral or accessory components 210 include a boot device selector, the boot device selector represents a selection feature in the wireless switch 112 that can be manipulated to control the manner in which the wireless switch 112 boots up in response to a reset command and/or a power-up condition.

In an embodiment in which the peripheral or accessory components 210 include a USB interface, the USB interface is suitably configured to facilitate data communication with USB compliant devices. The USB interface can includes a host controller, USB port, and/or USB port. The USB interface may be coupled to a PCI bus in the wireless switch 112, which can enable software downloads and potential firmware upgrades for the motherboard flash in the wireless switch 112.

In an embodiment in which the peripheral or accessory components 210 include a USB host controller, the USB host controller generally represents the hardware, software, firmware, processing logic, and/or other components of the USB interface that control data communication (which may be bi-directional) between the wireless switch 112 and USB compliant devices that might be connected to USB ports.

In an embodiment in which the peripheral or accessory components 210 include NAND flash memory, the NAND flash memory is realized as one or more 8-bit devices. The NAND flash memory may be employed as both a program storage device and a boot device (for normal operating conditions).

In an embodiment in which the peripheral or accessory components 210 include a portable flash memory card port, the portable flash memory card port is an interface that allows compatible flash memory cards to communicate with the main processor 202.

The peripheral or accessory components 210 can further include one or more fans and fan controls for cooling any portion of the wireless switch 112.

The wireless switch 112 can further include an additional processing element 214, which can be a daughterboard with respect to the main processing element 200. The additional processing element 214 can be, for example, an AMD Opteron application processor or Intel x86 processor. The additional processing element 214 can provide an additional server in the wireless switch 112 for additional and/or future processing applications within the wireless switch 112.

The additional processing element 214 includes an additional processing element processor 216. The additional processing element 214 further includes memory 218 and one or more additional processing element accessory or peripheral components 222.

The additional processing element processor 216 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

The memory 218 in the additional processing element processor 216 may be implemented or realized with RAM memory, flash memory, ROM memory, EPROM memory, EEPROM memory, registers, a hard disk, a removable disk, a CD-ROM, or any other form of storage medium known in the art. The memory 218 may be separate from or integrated with the additional processing element processor 216.

The one or more additional processing element accessory or peripheral components 222 can include one or more of the same components as the accessory or peripheral components 210 of the main processing element 200. The one or more additional processing element accessory or peripheral components 222 can also include one or more conventional accessory or peripheral components as in known in the art. The elements of additional processing element 214 may be interconnected together using a bus 224 or any suitable interconnection arrangement.

The additional processing element 214 interfaces with the main switch processor via the internal interface 208. The interconnect between the additional processing element 214 and the main processing element 200 can include a set of connectors and riser boards. For example, two connectors can support the data pairs with any interface requirements. The internal interface 208 can include a high speed bus 223 in the additional processing element 214 coupled to a high speed bus 211 in the main processing element 200. The high speed buses 211, 223 can be, for example, hypertransport buses, PCI-X buses, or the like. The internal interface 208 can enable communication between the additional processing element 214 and the main processing element 200 without requiring a significant amount from resources of the main processor 202 and/or the additional processing element processor 216.

Table 1 shows the interconnection signals between the additional processing element 214 and the main processing element 202 in an exemplary embodiment. The signals and usage are merely exemplary in nature and not limiting. Additional or alternate signals can be provided.

TABLE 1

| | Direction | |
|---|---|---|
| Signal | (Main Processing | |
| Name | Element View) | Usage |
| DBD_PRES | Input | Daughterboard present |
| | | 0 = Present, 1 = Not present |
| DBD_PWR_RSTJ | Input | Daughterboard |
| | | Power Supervisor |
| | | 1 = Power okay, 0 = Power fail |
| DBD_SYS_RSTJ | Bi- | Daughterboard Reset line |
| | Directional | 0 = Reset, 1 = Normal |
| | | Main can reset the |
| | | Daughterboard by holding |
| | | this line low |
| DBD_POST_OK | Input | Daughterboard POST Okay |
| | | indicator. |
| | | 0 = Fail, 1 = Pass (Valid only |
| | | if above true) |
| DBD_SCK | Output | I2C bus Clk line for |
| | | temperature Sensors |
| DBD_SDA | Bi-Dir | I2C data bus for |
| | | temperature Sensors |
| XLR_PWR_RSTJ | Output | Main Processing Element |
| | | Power Good |

The DBD_PRES signal indicates that the additional processing element 214 is present. Additional processing element 214 status is available via a register, for example on the intermediate processor. A one indicates the additional processing element 214 is not present, and a zero indicates that the additional processing element 214 is present.

The DBD_PWR_RSTJ signal is an active low signal from the additional processing element 214 to the main processing element 200 which indicates that the additional processing element 214 power supplies have not reached operating conditions. This signal is only valid if the DBD_PRES signal indicates that the additional processing element 214 is present. When this signal transitions to true, the additional processing element 214 will continue with system reset and POST. The state of this signal can be provided in a register in an intermediate processor.

The DBD_SYS_RSTJ signal corresponds to the additional processing element 214 reset line. It is a zero at power up reset and will remain low as long as the DBD_PWR_RSTJ is also low. It will transition from low to high some time after the DBD_PWR_RSTJ has transitioned from a low to high and its system clock is stable. This signal is open collector on the additional processing element 214 and can be asserted low by the main processing element 200 to cause the additional processing element 214 to reset. The state of this signal can be provided in a register in an intermediate processor. It is only valid if the DBD_PRES line is low.

The DBD_POST_OK signal indicates, when high, indicates that the additional processing element 214 has successfully booted and completed its power on diagnostics. If this line remains lows after SYS_RSTJ signal is negated, then the DBD_POST_OK signal indicates that the additional processing element 214 did not pass its initial diagnostics. At this time, the main processing element 200 should set an alarm indicating that the additional processing element 214 is not functioning. This signal is only valid if the DBD_PRES signal is low.

The DBD_SCK and DBD_SDA signals make up an I2C bus which can run between the additional processing element 214 to the main processing element 200. The primary function of this bus is to read the temperatures of specified components on the additional processing element 214. These signals are valid only if the DBD_PRES signal is low.

The XLR_POST_OK signal, when asserted high, indicates to the additional processing element 214 that the main processing element 200 is functional. If this signal is low, the additional processing element 214 should assume that the main processing element 200 is not functional.

The XLR_PWR_RSTJ signal corresponds to the reset line of the main processing element 200. This signal indicates that all the supplies on the main processing element 200 are at the correct operating state. If this signal is not true, the additional processing element 214 should also enter power reset.

The additional processing element 214 will provide users with the flexibility to have an “all in one” wireless switch 112. Particularly, the main processing element 200 can be used for wireless and RF switching and the additional processing element 214 allows access to future products such as a mobility server. Users can also utilize the connections on the additional processing element 214 for storage of network logging information.

Moreover, the wireless switch 112 can use a single user interface 226 for both processing elements. The user interface 226 can be a graphical user interface.

In one exemplary embodiment, the additional processing element 214 communicates with the main processing element 200 to provide the switching intelligence and processing logic to ensure that data for a given communication session is directed to and from the correct wireless access device. As mentioned above, an access device connects users to other users within the network and can also serve as the point of interconnection between a WLAN and a fixed wire network. Each access device can serve multiple users within a defined network area. As a wireless client moves beyond the range of one access device, the wireless client can be automatically handed over to another access device, e.g., a different access point or a wireless access port supported by a wireless switch. In practice, the number of wireless access devices in a given network generally increases with the number of network users and the physical size of the network. The additional processing element 214 can provide RFID management, intrusion detection management, and other management functions.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A wireless local area network (WLAN) comprising:
a wireless switch coupled to a network, the wireless switch comprising a main processing element and an additional processing element; and
a plurality of wireless access devices configured to receive outgoing data packets from the wireless switch and to provide incoming data packets to the wireless switch.

2. The WLAN of claim 1, wherein the main processing element includes a main processing element processor and a main processing element memory, and the additional processing element includes an additional processing element processor and an additional processing element memory.

3. The WLAN of claim 1, wherein the wireless switch further includes an interface between the main processing element and the additional processing element.

4. The WLAN of claim 3, wherein the interface includes a PCI-X bus.

5. The WLAN of claim 3, wherein the interface includes a hypertransport bus.

6. The WLAN of claim 1, wherein the main processing element and the additional processing element form a single package.

7. The WLAN of claim 1, wherein the wireless switch further includes a single graphical user interface for interfacing with the main processing element and the additional processing element.

8. The WLAN of claim 1, wherein the additional processing element is a server.

9. The WLAN of claim 1, wherein the additional processing element is a daughterboard with respect to the main processing element

10. A wireless switch for coupling an access device to a network in a wireless local area network (WLAN), the wireless switch comprising:
a main processing element including a main processing element processor and a main processing element memory, and
an additional processing element including an additional processing element processor and an additional processing element memory.

11. The wireless switch of claim 10, further comprising an interface between the main processing element and the additional processing element.

12. The wireless switch of claim 11, wherein the interface includes a PCI-X bus.

13. The wireless switch of claim 11, wherein the interface includes a hypertransport bus.

14. The wireless switch of claim 10, wherein the main processing element and the additional processing element form a single package.

15. The wireless switch of claim 10, further comprising a single graphical user interface for interfacing with the main processing element and the additional processing element.

16. The wireless switch of claim 10, wherein the additional processing element is a server.

17. The wireless switch of claim 10, wherein the additional processing element is a daughterboard with respect to the main processing element.

18. A wireless switch for coupling an access device to a network in a wireless local area network (WLAN), the wireless switch comprising:
a main processing means having a main processing means processor and a main processing means memory,
an additional processing means having an additional processing means processor and an additional processing means memory; and
an interface coupling the main processing means to the additional processing means.

19. The wireless switch of claim 18, wherein the interface comprises a PCI-X bus.

20. The wireless switch of claim 18, wherein the interface comprises a hypertransport bus.
